(19) United States
(12) Patent Application Publication
(10) Pub. No.: US 2013/0138355 A1
(43) Pub. Date: May 30, 2013

(54) METHOD AND SYSTEM FOR EVALUATING SEQUENCES

(71) Applicants: Stuart John INGLIS, Hamilton (NZ); Leonard Eric TRIGG, Ngahinapouri (NZ); Alan Timothy Jon JACKSON, Hamilton (NZ); Sean Alistair IRVINE, Hamilton (NZ)

(72) Inventors: Stuart John INGLIS, Hamilton (NZ); Leonard Eric TRIGG, Ngahinapouri (NZ); Alan Timothy Jon JACKSON, Hamilton (NZ); Sean Alistair IRVINE, Hamilton (NZ)

(21) Appl. No.: 13/681,046

(22) Filed: Nov. 19, 2012

Related U.S. Application Data
(63) Continuation of application No. PCT/NZ2011/000080, filed on May 20, 2011.

(30) Foreign Application Priority Data
May 20, 2010 (NZ) 585505
May 21, 2010 (NZ) 585532
Jun. 8, 2010 (NZ) 585984

(51) Int. Cl. G06F 19/16

(52) U.S. Cl. CPC G06F 19/16
USPC 702/19

(57) ABSTRACT

A method of evaluating correlation between sequences by employing a hierarchy of evaluation algorithms. The evaluation algorithms may be arranged in order of computational efficiency as specified by a user or as determined by the system. The algorithms may range from a simple equality algorithm through to seeded alignment algorithms etc.

Distributed and parallel processing systems may be employed in the method of the invention in graphical processing units may be employed.

The method may be employed with a wide range of sequencers including sequencers produced by Illumina Inc Complete Genomics Inc. and Pacific Biosciences Inc.

### CROSS REFERENCE TO RELATED APPLICATIONS

This is a continuation of PCT Application No. PCT/NZ2011/000080, with an international filing date of May 20, 2011, which claims priority to New Zealand Application No. NZ585505, filed May 20, 2010, New Zealand Application No. NZ585532, filed May 21, 2010, and New Zealand Application No. NZ585594, filed Jun. 8, 2010. PCT Application No. PCT/NZ2011/000080, filed May 20, 2011, is incorporated herein by reference in its entirety.

### FIELD OF THE INVENTION

The invention relates to a method and system for the computationally efficient evaluation of the correlation of sequences, particularly, although not exclusively, nucleotide or protein sequences.

### BACKGROUND TO THE INVENTION

The analysis of nucleotides to determine correlation between a sample sequence and a reference sequence may be computationally demanding. Sequences consist of multiple elements where the order of the elements in the sequence is important. Each element consists of a value, and different elements may have the same or different values. For genetic sequences, such as DNA or RNA, each element of the segment may take on one of the following values: A, C, G, T, and U. The length of a segment may vary from relatively small (for example thousands) to large (for example billions).

In general, a first sample sequence (known as a “read”) is analysed with regard to a second reference sequence, typically a genome. Often the reference sequence is a longer sequence than the sample sequence, and it is desired to determine whether the reference contains a segment that is similar or the same as the sample sequence. Reads may be contiguous, as with sequencers produced by Illumina Inc. or be non-continuous or overlapping, as with sequencers produced by Complete Genomics Inc. and Pacific Biosciences Inc. It is desirable for evaluation algorithms to be able to process any type of read.

Algorithms, such as the Smith Waterman algorithm and its derivatives, have been developed to compare different genomic sequences. Where the goal of the algorithm is to position a smaller sequence within a larger sequence, this algorithm is known as a gapped alignment algorithm. In many cases, the larger sequence is much longer than the smaller sequence, and as a result it is possible that there is more than one location in the larger sequence that is similar to the smaller sequence. There are often small differences between the sample sequence and the corresponding segment of the reference sequence. These errors may be random or systematic of the source of the sample sequence. For example, in the case of DNA sequences, the DNA sequencer reads each nucleotide in the read, but may incorrectly call the correct type as another. Another source of error is that the DNA segments may naturally be different to the reference genome. Differences include SNP (single nucleotide differences), MNP (multiple), large movements in a region of DNA, multiple copies of a region of DNA. Errors and differences may be accounted for by using masking techniques as described in other systems, such as in the applicant's international patent application Patent Application No. PCT/NZ2009/000245. Thus it may take a significant amount of computing time to evaluate a sample sequence at each position of a reference sequence for all relevant permutations.

Therefore, the goal of an alignment algorithm is to attempt to position the sample sequence within the reference sequence with the best possible match within as short as possible a processing time. This may involve placing an entire read (e.g. as many of the nucleotides in the read as possible) starting at a specific location. Alternatively we may wish to determine if parts of the read (for example, chimeric reads) are from different locations in the reference.

It is an object of the present invention to provide a method and system for evaluating the correlation of sequences that is more computationally efficient than prior techniques or which at least provides the public with a useful choice.

### SUMMARY OF THE INVENTION

According to a first aspect there is provided a computer implemented method of evaluating a sequence using a plurality of evaluation algorithms, comprising applying the evaluation algorithms in an order designed to minimise the processing time for carrying out the required evaluation.

According to a further aspect there is provided a computer implemented method of evaluating the correlation between a sample sequence and a reference sequence using a plurality of evaluation algorithms, comprising applying the evaluation algorithms in an order designed to minimise the processing time for carrying out the required evaluation.

There is also disclosed a sequencing system comprising:
a. a sequencer for obtaining sample sequences; and
b. processing means for evaluating sample sequences from the sequencer with respect to one or more reference sequences using a plurality of evaluation algorithms which are applied in an order designed to minimise the processing time for carrying out the required evaluation.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows the sequence of application of evaluation algorithms according to one embodiment;

FIG. 2 shows the comparison of a reference sequence and a sample sequence in step 1;

FIG. 3 shows the comparison of a reference sequence and a sample sequence in step 2;

FIG. 4 shows the comparison of a reference sequence and a sample sequence in step 3;

FIG. 5 shows a distributed sequence analysis system; and

FIG. 6 shows a parallel processing system according to one embodiment.

### DETAILED DESCRIPTION

The invention will now be described by way of example only, with reference to examples based on the analysis of nucleotide sequences in the form of genomic sequences of DNA or RNA.

It is usual for different evaluation algorithms to have different properties with regard to speed and the number and frequency of matches between a sample sequence and a reference sequence.

Here, speed refers to how quickly the evaluation algorithm is able to produce results, whereas the quality represents the strength of a match (i.e. an identical match is the most significant and less statistically relevant matches are less significant).

Some alignment algorithms may be fast and produce strong matches, such as a simple “equality sequence aligner algorithm” which simply determines whether there is an exact match.

A fast algorithm may produce many possible “fires” (matches according to specified match criteria) in a short time, whereas a slow algorithm may produce a few possible areas of alignment in a long time. Evaluation algorithms may be ordered based on their number of matches and frequency of matches.

Take for example:
Algorithm 1 “fires” on 20% of the data and runs at 2000 alignments/sec
Algorithm 2 “fires” on 30% of the data and runs at 3000 alignments/sec

Algorithm 3 “fires” on 10% of the data and runs at 100,000 alignments/sec

Algorithm 3 makes the least alignments but it is so fast that if run first it may reduce the remaining data down to 90% resulting in a massive time savings. The quality of the matches produced by different algorithms may also be taken into account in determining the order of application of algorithms.

Based on knowledge of the characteristics of evaluation algorithms (their speed, number of matches with respect to processing time and statistical quality of matches) their order of application may be prescribed so as to minimise typical processing time.

The present system uses a set of evaluation algorithms one after another to evaluate potential alignment positions with high efficiency. In a multi-processor system a number of evaluation algorithms may be run in parallel and allocated to processors based on their speed and performance characteristics of the processors. For example slower processors may be allocated algorithms with short processing times (such as identity/equality algorithms) so that the results of that algorithm are not unduly delayed.

In the general case, the system uses faster evaluation algorithms first to reduce the number of potential alignment positions before using slower evaluation algorithms that may produce more and/or better quality matches to further reduce the number of potential alignment positions. However, due to different properties of the data and equipment, different orders of evaluation algorithms may be appropriate and the system is designed to also account for these factors.

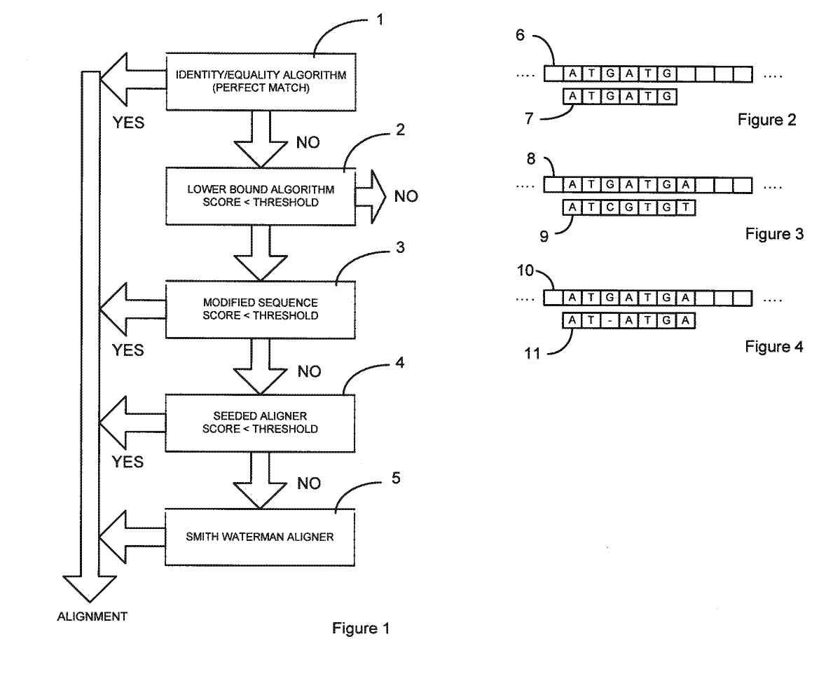

Referring to FIG. 1 one possible sequence of evaluation algorithms will be described. Initially, there are nominally as many alignment positions in the reference sequence as there are elements in the reference system. In this embodiment, an initial alignment is performed in step 1 in which the reference sequence 6 in FIG. 2 is searched for exact matches to the sample sequence 7 in FIG. 2 (“equality sequence alignment”).

If one or more exact matches are discovered, then the one or more alignment positions are recorded as alignment positions with perfect alignment. For long reads it is highly unlikely that a position within the genome exactly matches with the sample sequence randomly, and so there is a high probability that at most one exact match will be found and that this will be the correct alignment. The probability of correct alignment is higher for longer sample sequences (the present embodiment typically employs sample sequences of about 18 to 22 bases). In this embodiment, if one alignment position is found in this step, the system ceases searching and returns the location of alignment with the reference sequence as the alignment position.

If an exact match is not found, or it is desired to also find similar but not exact alignment positions, then further evaluation algorithms may be applied.

In this embodiment, the sample sequence and reference sequence are then run through a lower bound algorithm 2. The purpose of this algorithm is to perform a first sample on the sequences by performing a coarse search of the reference sequence to ensure that there is a reasonable chance of discovering alignment positions for the sample sequence in the reference sequence. In this search the unmodified sample sequence is compared to the reference sequence and alignments are scored based on the quality of the alignment—i.e. points are added according to the nature of the misalignments to form a cumulative score at each position (as shown in FIG. 3 the sequences differ at two positions and the score at this position will be the cumulative value ascribed to these misalignments—e.g. “0” for matches and “1” for a substitution). If the score is greater than a threshold the sample sequence is rejected and if not processing proceeds to evaluation algorithm 3. This test is useful if there is a reasonable chance that the sample sequence is not related to the reference sequence and therefore unlikely to match at any point.

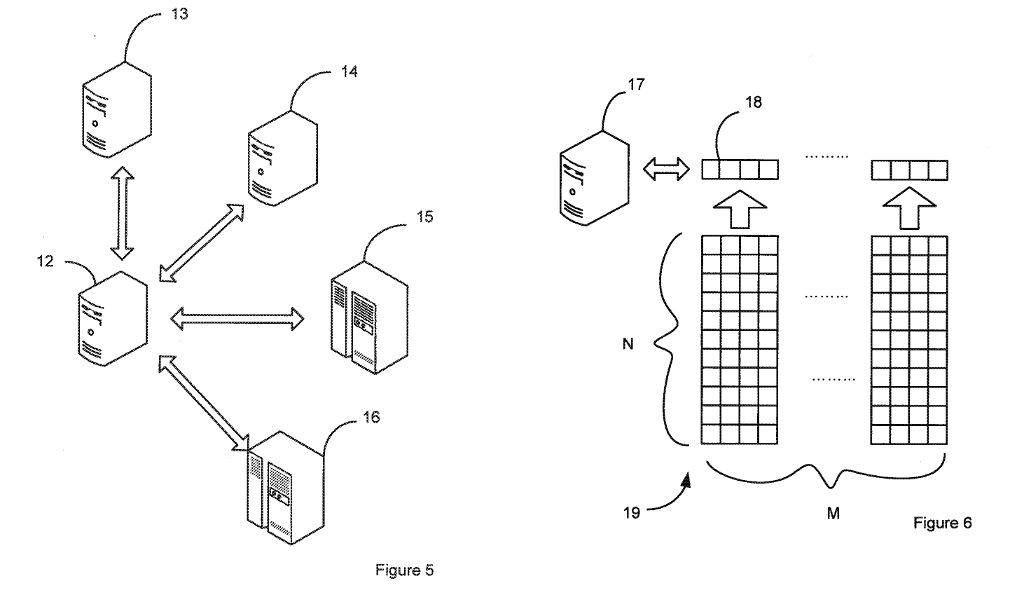

In step 3 the sample sequence is modified at each potential alignment position with the reference sequence. FIG. 4 illustrates an insertion in sample sequence 11 to achieve an alignment with reference sequence 10 (which may attract a score of “2” for example). The modifications to the sample sequences may be produced as set out in the applicant's international patent application Patent Application No. PCT/NZ2009/000245. The values ascribed to each modification will depend upon the sequencing machine employed, the type of sequence, the chemistry, a characteristic of the sequence etc. Modifications may be limited to those having a cumulative score below the acceptance threshold for the algorithm. Characteristics of the sequences may be obtained by preliminary analysis of the sequences. Alternatively these may be entered by a user.

In step 4 a seeded aligner is employed in which portions of the sample sequence that match the reference sequence are positioned and detailed evaluation algorithms analyse the gaps between the seeds. If a match with a score below a threshold value is found then this alignment may be recorded and processing may terminate.

If no alignment has a score below the threshold then a final evaluation algorithm 5 may be employed. This may be an algorithm that returns the best alignment. The further evaluation algorithms may be an algorithm based on the Smith Waterman algorithm such as the Gotoh aligner or Edit Distance aligner.

In one embodiment, the series of alignment algorithms may be predetermined before the system is run, which may be set by the user. In another embodiment, the series is at least in part determined by one or more parameters of the job. For example, the length of the sample sequence, information on the source of the sample sequence (i.e. the equipment that the sample sequence is sourced from), the alignment score desired by the user, and the specific knowledge of the reference sequence properties. In one embodiment, the series may be altered between applications of evaluation algorithms due to the results of the evaluation algorithms.

The first evaluation algorithm applied in general is a fast searching algorithm. The purpose of it is to reduce the number of potential alignment positions from being every position in the reference sequence to a smaller set of positions. Then typically a second, high coverage, but slower, evaluation algorithm is used to further reduce the set of potential alignment positions. Further evaluation algorithms may be applied until the set of alignment positions only contains alignments with better scores than the minimum set by the user. In one embodiment, the user selects a maximum operating time and/or number of evaluation algorithms to use, and once either of these conditions is met the system finishes searching for alignment positions. One of the evaluation algorithms may be a weighted probability algorithm that outputs a weighted probability of each position in the read being a variety of states (ATCG, deleted, etc). The weighted probability is a function of all possible “paths” from the start of the read to the end of the read.

In one embodiment, coarser searching algorithms (simple positioning algorithms) are used to obtain a set of possible alignment positions, and the finer searching algorithms (local or global alignment algorithms) are used to reduce this set until a specified level or certainty is reached. However, it is understood that depending on a variety of factors, different orders of algorithms may be used and different types. The ordering may be based upon historical information as to the performance of evaluation algorithms, a characteristic of the sequences concerned, the sequencing equipment used to obtain reads etc. A characteristic of the sequence may be obtained by user input or by preliminary analysis of one or more sequence. The system may also dynamically select the order of evaluation algorithms based on the results of algorithms that have already run or the order may be set at the start of processing or preset for a specific analyser. An evaluation algorithm engine may determine the order of application of algorithms and may be a rule based engine or artificial intelligence engine employing a neural network or genetic algorithm to select algorithm ordering. The evaluation algorithm engine may also include a “Meta-aligner” which alters the relative positioning of sequences as well as selecting the algorithms to apply. Such a Meta-aligner may be applied as a final algorithm to run in loops to attempt to find an alignment above a required threshold.

In one embodiment, a user selects a minimum alignment score. The alignment score is a measure of how well a segment of the reference sequence matches to the sample sequence. Typically, a higher score is given to segments which align well with the sample sequence. In one case, the score is a relative value, for example 90%, and limits possible segments to those that match within 90% of the sample sequence. The threshold may be based on “local alignment” where the score is determined based on alignment of only a portion of the sequences.

Referring to FIG. 5 a distributed sequence analysis system is shown. Sample and reference sequences are supplied to primary processor 12 which assigns tasks to secondary processors 13 to 16. In this embodiment processors 15 and 16 have greater capacity than processors 13 and 14. Primary processor 12 thus assigns processors 13 and 14 to process more efficient algorithms and processors 15 and 16 are assigned the more computationally involved algorithms.

Referring to FIG. 6 a parallel processing system according to one embodiment is shown. A primary processor 17 controls M parallel processing units 18, which may conveniently be graphics processing units. In this embodiment the complete index of reads may be divided between parallel processing units 18 and reference sequences 19 may be streamed therethrough. In one embodiment M copies of the reference sequence that is N long may be streamed through the parallel processors. The index values supplied to parallel processors 18 may include various modifications of the reads (i.e. indels and substitutions) and/or multiple sample sequences. The parallel processing unit of FIG. 6 may be one of the secondary processors shown in FIG. 5.

By ordering evaluation algorithms based on their processing time and likelihood of producing a determinative outcome processing time can be dramatically reduce.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

### EXEMPLARY EMBODIMENTS

1. A computer implemented method of evaluating the correlation between a sample sequence and a reference sequence using a plurality of evaluation algorithms, comprising applying the evaluation algorithms in an order designed to minimise the processing time for carrying out the required evaluation.
2. A method as claimed in claim 1 wherein the algorithms are ordered according to the number and/or frequency of matches with respect to processing time.
3. A method as claimed in claim 1 wherein the algorithms are ordered according to the number and frequency of matches with respect to processing time.
4. A method as claimed in any one of the preceding claims wherein at least one of the evaluation algorithms includes a rejection outcome.
5. A method as claimed in claim 4 wherein the rejection outcome results in no further evaluation algorithms being applied.
6. A method as claimed in any one of the previous claims wherein at least one of the evaluation algorithms includes an acceptance outcome.
7. A method as claimed in claim 6 wherein the acceptance outcome results in no further evaluation algorithms being applied.
8. A method as claimed in claim 6 or claim 7 wherein the acceptance outcome includes an evaluation result.
9. A method as claimed in any one of the previous claims where at least one of the evaluation algorithms includes a rejection outcome.
10. A method as claimed in claim 9 wherein the rejection outcome results in the next evaluation algorithm being applied.
11. A method as claimed in any one of the preceding claims wherein the first evaluation algorithm applied is an identity algorithm.
12. A method as claimed in any one of the preceding claims wherein a lower bound algorithm is applied to evaluate whether a comparison of the unmodified sample sequence and reference sequence results in a score within an acceptance range.
13. A method as claimed in claim 12 wherein the sample sequence is rejected if the score is outside the acceptance range and no further algorithm is applied.
14. A method as claimed in any one of the preceding claims wherein an algorithm is applied to evaluate whether a comparison of a modified form of the sample sequence and the reference sequence results in a score within an acceptance range.
15. A method as claimed in claim 14 wherein the score is modified based on the extent of modification of the sample sequence.
16. A method as claimed in any one of the preceding claims wherein one or more seeded alignment algorithm is employed.
17. A method as claimed in claim 16 wherein the one or more seeded alignment algorithm is employed.
18. A method as claimed in claim 17 wherein the one or more seeded alignment algorithm is based on the Smith Waterman aligner.
19. A method as claimed in any one of the previous claims wherein the order of application of algorithms is based on user input.
20. A method as claimed in any one of the previous claims wherein the order of application of algorithms is set by an ordering algorithm.
21. A method as claimed in any one of the preceding claims wherein an artificial intelligence engine determines the order of application of the evaluation algorithms.
22. A method as claimed in claim 21 wherein the artificial intelligence engine employs a neural network.
23. A method as claimed in claim 21 wherein the artificial intelligence engine employs a genetic algorithm.
24. A method as claimed in claim 19 wherein the ordering algorithm uses historical sequencing information to determine the order.
25. A method as claimed in any one of claims 19 to 24 wherein the ordering algorithm uses known information on the efficiency of the evaluation algorithms to determine the order.
26. A method as claimed in any one of claims 19 to 25 wherein the ordering algorithm uses source information relating to a sequence to determine the order.
27. A method as claimed in claim 26 wherein the source information includes at least one of: the sequencing equipment used to obtain the sample sequence; the type of sequence; and a characteristic of a sequence.
28. A method as claimed in claim 27 wherein a characteristic of a sequence is obtained by preliminary analysis of the sequence.
29. A method as claimed in any one of the previous claims wherein the order of application of evaluation algorithms is set before the application of the evaluation algorithms.
30. A method as claimed in any one of claims 1 to 28 wherein the order of application of evaluation algorithms is modified during the evaluation.
31. A method as claimed in claim 30 wherein the order is modified based on analysis of the previous and/or current evaluation algorithm results and/or performance.
32. A method as claimed in any one of the previous claims including setting an acceptance threshold, wherein the sequence evaluation ceases once the acceptance threshold has been met.
33. A method as claimed in any one of the previous claims wherein the evaluation results in a further sequence being aligned to the sample sequence being evaluated.
34. A method as claimed in claim 33 wherein the further sequence and the associated alignment information is recorded.
35. A method as claimed in claim 34 wherein the record is readable by a computer.
36. A method as claimed in any one of the previous claims wherein the sample sequence is a nucleotide sequence.
37. A method as claimed in any one of claims 1 to 35 wherein the sample sequence is a genomic sequence.
38. A method as claimed in claim 37 wherein the sample sequence is a DNA sequence.
39. A method as claimed in claim 37 wherein the sample sequence is a RNA sequence.
40. A method as claimed in any one of the preceding claims wherein at least one evaluation algorithm includes a positioning algorithm with changes the relative positioning of sample and reference sequences and one or more evaluation algorithm which iteratively evaluates local or global alignment at the various relative positions of the sequences.
41. A method as claimed in any one of the preceding claims wherein one of the evaluation algorithms outputs a weighted probability.
42. A system for implementing the method of any one of the previous claims.
43. A system as claimed in claim 42 wherein the system employs parallel processing.
44. A sequencing system comprising:
   a. a sequencer for obtaining sample sequences; and
   b. processing means for evaluating sample sequences from the sequencer with respect to one or more reference sequences using a plurality of evaluation algorithms which are applied in an order designed to minimise the processing time for carrying out the required evaluation.
45. A sequencing system as claimed in claim 44 employing the method of any one of claims 1 to 40.
46. A sequence analysis system employing multiple processors running multiple evaluation algorithms wherein evaluation algorithms are allocated to processors based upon performance characteristics of the processors.
47. A sequence analysis system as claimed in claim 46 wherein some of the processors are processors arranged to perform parallel processing of an algorithm.
48. A sequence analysis system as claimed in claim 47 wherein the parallel processors are graphics processors.

What is claimed is:

1. A computer implemented method of evaluating the correlation between a plurality of sample sequences and a reference sequence using a plurality of evaluation algorithms, comprising applying the evaluation algorithms in an order designed to minimise the processing time for evaluating the correlation, wherein the plurality of evaluation algorithms comprises:
a lower-bound algorithm which rejects alignments of the sample sequences in unmodified form to the reference sequence if an alignment quality threshold is not satisfied; and
a modified sequence alignment algorithm in which the sample sequences are modified at potential alignment positions with the reference sequence, with the set of modifications of the sample sequence comprising an insertion.

2. A method as claimed in claim 1 wherein the plurality of evaluation algorithms further comprises at least one additional algorithm chosen from:
an equality sequence aligner algorithm;
a seeded alignment algorithm; and
an algorithm that returns an optimal alignment.

3. A method as claimed in claim 2 wherein the first evaluation algorithm applied is an equality sequence aligner algorithm.

4. A method as claimed in claim 2 wherein the plurality of evaluation algorithms comprises at least one seeded alignment algorithm.

5. A method as claimed in claim 4 wherein the plurality of evaluation algorithms comprises a seeded alignment algorithm based on the Smith Waterman aligner.

6. A method as claimed in claim 1 wherein the algorithms are ordered according to the number or frequency of matches with respect to processing time.

7. A method as claimed in claim 1 wherein the algorithms are ordered according to the number and frequency of matches with respect to processing time.

8. A method as claimed in claim 1 wherein at least one of the evaluation algorithms includes an acceptance outcome which results in no further evaluation algorithms being applied.

9. A method as claimed in claim 1 wherein the order of application of algorithms is based on user input.

10. A method as claimed in claim 1 wherein the order of application of algorithms is set by an ordering algorithm.

11. A method as claimed in claim 10 wherein the ordering algorithm uses historical sequencing information to determine the order.

12. A method as claimed in claim 10 wherein the ordering algorithm uses known information on the efficiency of the evaluation algorithms to determine the order.

13. A method as claimed in claim 1 wherein an artificial intelligence engine determines the order of application of the evaluation algorithms.

14. A method as claimed in claim 12 wherein the artificial intelligence engine employs a neural network or genetic algorithm.

15. A method as claimed in claim 1 wherein the order of application of evaluation algorithms is set before the application of the evaluation algorithms.

16. A method as claimed in claim 1 wherein the order of application of evaluation algorithms is modified during the evaluation.

17. A method as claimed in claim 16 wherein the order is modified based on analysis of the previous or current evaluation algorithm results or performance.

18. A method as claimed in claim 1 wherein the sample sequence is a nucleotide sequence.

19. A method as claimed in claim 18 wherein the nucleotide sequence is a genomic sequence.

20. A method as claimed in claim 19 wherein the genomic sequence is a DNA sequence.

21. A method as claimed in claim 18 wherein the nucleotide sequence is a RNA sequence.

22. A method as claimed claim 1 wherein at least one evaluation algorithm includes a positioning algorithm which changes the relative positioning of sample and reference sequences and one or more evaluation algorithm which iteratively evaluates local or global alignment at the various relative positions of the sequences.

23. A method as claimed in claim 1 wherein at least one of the evaluation algorithms outputs a weighted probability.

24. A system configured to perform a computer implemented method of evaluating the correlation between a plurality of sample sequences and a reference sequence using a plurality of evaluation algorithms, comprising applying the evaluation algorithms in an order designed to minimise the processing time for evaluating the correlation, wherein the plurality of evaluation algorithms comprises:
a lower-bound algorithm which rejects alignments of the sample sequences in unmodified form to the reference sequence if an alignment quality threshold is not satisfied; and
a modified sequence alignment algorithm in which the sample sequences are modified at potential alignment positions with the reference sequence, with the set of modifications of the sample sequence comprising an insertion.

25. A system as claimed in claim 24 wherein the system comprises parallel processors and is configured to employ parallel processing to apply the plurality of evaluation algorithms.

26. A system as claimed in claim 25 wherein the evaluation algorithms are allocated to processors based upon performance characteristics of the processors.

27. A sequence analysis system as claimed in claim 25 wherein the parallel processors comprise graphics processors.

28. A system as claimed in claim 24, further comprising a sequencer for obtaining sample sequences for evaluation by the plurality of evaluation algorithms.
